(19) United States
(12) Patent Application Publication
(10) Pub. No.: US 2025/0351786 A1
(43) Pub. Date: Nov. 20, 2025

(54) BLOWER WITH VIBRATION ISOLATION FEATURES

(71) Applicant: Milwaukee Electric Tool Corporation, Brookfield, WI (US)

(72) Inventors: Jonathan Schmitz, Brookfield, WI (US); Hayden Huttula, Brookfield, WI (US); Andrew Medeiros-Nicholson, Brookfield, WI (US); Robert K. Paddock, Waukesha, WI (US)

(21) Appl. No.: 19/208,195

(22) Filed: May 14, 2025

Related U.S. Application Data
(60) Provisional application No. 63/648,684, filed on May 17, 2024.

(51) Int. Cl. A01G 20/47; B23K 20/10; F04D 29/66

(52) U.S. Cl. CPC A01G 20/47; B23K 20/10; F04D 29/668

(57) ABSTRACT

A blower and a method of manufacturing a motor assembly for a blower are provided. A blower includes a main body, an air duct extending between an air inlet and an air outlet, the air duct including air duct body; a motor disposed in the air duct body; and a fan disposed in the air duct body. The fan and the motor are disposed in a fan assembly housing. The blower further includes at least one Noise Vibration Harshness (NVH) material within the air duct, the NVH material being configured to isolate mechanical vibration of the housing from the air duct.

### CROSS-REFERENCE TO RELATED APPLICATIONS

The present application claims priority to U.S. Provisional Patent Application Ser. No. 63/648,684 filed on May 17, 2025, the disclosure of which is incorporated by reference herein in its entirety.

### FIELD

The present disclosure relates generally to blowers, and more particularly to blowers having vibration isolation features.

### BACKGROUND

Blowers are generally used to produce and output a stream of air to be directed by the user. Blowers are frequently utilized in outdoor applications, such as to blow leaves and other debris. Homeowners frequently utilized such blowers to clean their yards and outdoor spaces. The types of blowers can vary between backpack-style blowers and handheld blowers, as well as between gas-powered and electric blowers. Electric blowers can be corded and plugged into electrical outlets, or can be cordless and battery powered.

One issue with many power tools, including blowers, is the vibration and noise generated during operation. Such vibration and noise may emanate from engines, fan blades, and other moving and stationary components of the power tools. Vibration generated during operation may be transmitted to a user via a user interface of the blower or tool, which While quieter power tools can be produced simply by reducing the power and performance level of the power tool, the resulting product is not desirable to the customer due to the lack of performance.

Accordingly, improved blowers which include vibration and noise reduction features while not having diminished performance are desired. In particular, blowers which include both reduced noise generation and improved performance characteristics would be advantageous.

### BRIEF DESCRIPTION

Aspects and advantages of the present disclosure will be set forth in part in the following description, or may be obvious from the description, or may be learned through practice of the technology.

In accordance with one embodiment, a blower is provided. The blower includes a main body; an air duct extending between an air inlet and an air outlet opposite the air inlet, the air duct including air duct body; a motor disposed in the air duct body between the air inlet and the air outlet; and a fan disposed in the air duct body between the air inlet and the air outlet. The fan is configured to rotate about a fan axis, and includes a fan hub and a plurality of fan blades extending radially outwardly from the fan hub to include a fan tip. The fan and the motor are disposed in a fan assembly housing. The blower further comprises at least one Noise Vibration Harshness (NVH) material within the air duct. The NVH material is configured to isolate mechanical vibration of the housing from the air duct.

In accordance with another embodiment, a method of manufacturing a motor assembly is provided. The method includes steps of: forming a cylindrical motor housing; forming a plurality of stator blades; and forming a cylindrical shroud. The method further includes steps of joining the plurality of stator blades to an outer surface of the motor housing, and joining the plurality of stator blades to an inner surface of the shroud. At least one of the plurality of stator blades is joined to the motor housing and/or the shroud by vibrational welding.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a blower in accordance with embodiments of the present disclosure;

FIG. 2 is a partial cutaway view of a blower assembly in accordance with embodiments of the present disclosure;

FIG. 3 is a partial cross-sectional view of a blower assembly and air duct in accordance with embodiments of the present disclosure;

FIG. 4 is a partial cross-sectional view of a motor assembly in accordance with embodiments of the present disclosure; and

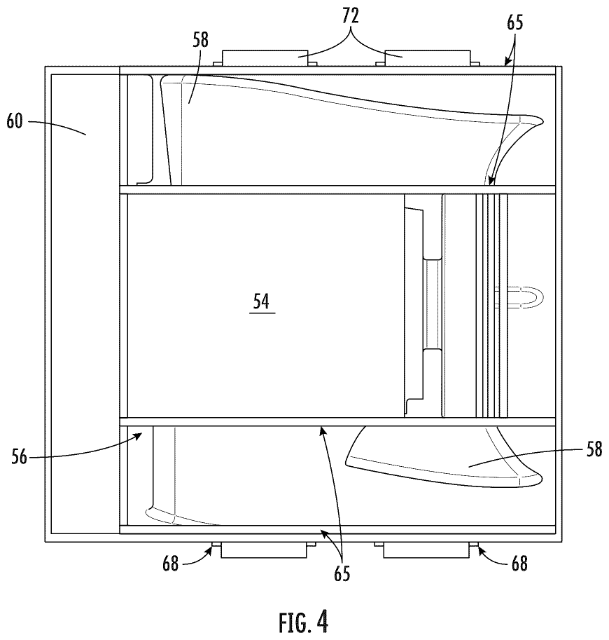

FIG. 5 is a partial front view of a blower in accordance with embodiments of the present disclosure.

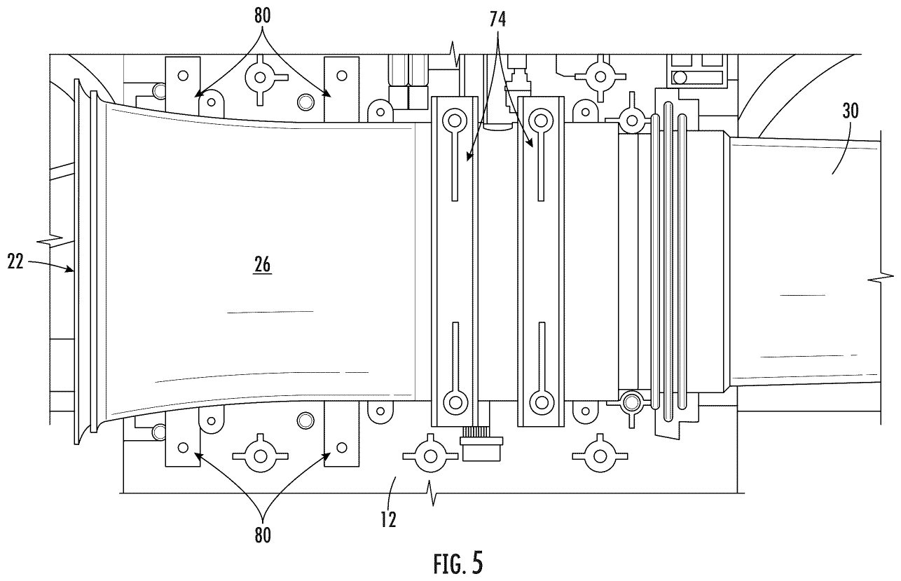

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises”, “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

“Noise, Vibration, Harshness (“NVH”) material” shall mean any material designed to be noise and/or vibration reducing, such as by absorbing noise and vibration, including but not limited to rubber, cork, foam, foam/film laminates, such as polyurethane foam, polyurethane elastomer, polyolefin elastomers and resins, acrylic liquid applied sound damping, polyester and/or polypropylene fibers. NVH materials may be in the form of foam, resins, liquid applied coating materials, flexible acoustic materials, flexible damping material, or any other suitable form.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present invention is directed to a blower having an isolated motor and fan assembly. The blower includes a motor and fan assembly disposed within an air duct of the blower, and the motor and fan assembly is isolated from an air duct body by at least one dampening material such as an NVH material. The inlet end of the blower air duct upstream of the motor and fan assembly may further include at least one dampening material such as an NVH material surrounding the air duct along the air duct body. In this manner, during operation of the blower, mechanical vibration generated by operation of the motor and fan may be isolated from the air duct body and the blower housing, thereby reducing noise generated by the mechanical vibrations as compared to conventional blowers.

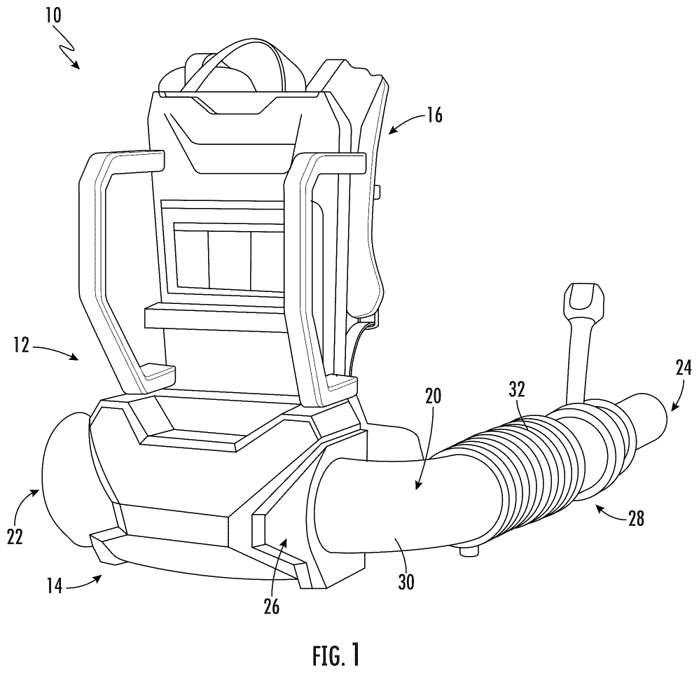

Referring now to the drawings, FIG. 1 illustrates a blower tool 10 having a main body 12 and a blower unit 14. While the blower 10 illustrated in FIG. 1 is a backpack blower configured to be worn on a user's back, e.g., with backpack supports 16, the features of the present invention may be implemented for a handheld blower (not illustrated), e.g., a handheld axial fan blower or a centrifugal fan blower.

The blower unit 14 includes an air duct 20 extending from an air inlet 22 to an air outlet 24. The air duct 20 may be formed by an air duct body 26 and a blower tube 28. For instance, the air duct body 26 may define the air inlet 22 at one end thereof. The air duct body 26 may be coupled, directly or indirectly, with the blower tube 28 at an opposite end relative to the air inlet 22. For instance, an elbow tube 30 may be provided between the air duct body 26 and the blower tube 28 as shown in FIG. 1. Alternatively, e.g., in a handheld blower (not shown), the air duct body 26 may be directly coupled to the blower tube 28. In some arrangements, a bellows 32 may be provided between the air duct body 26 and the blower tube 28, e.g., to enable the blower tube 28 to pivotably move and/or rotate relative to the air duct body 26.

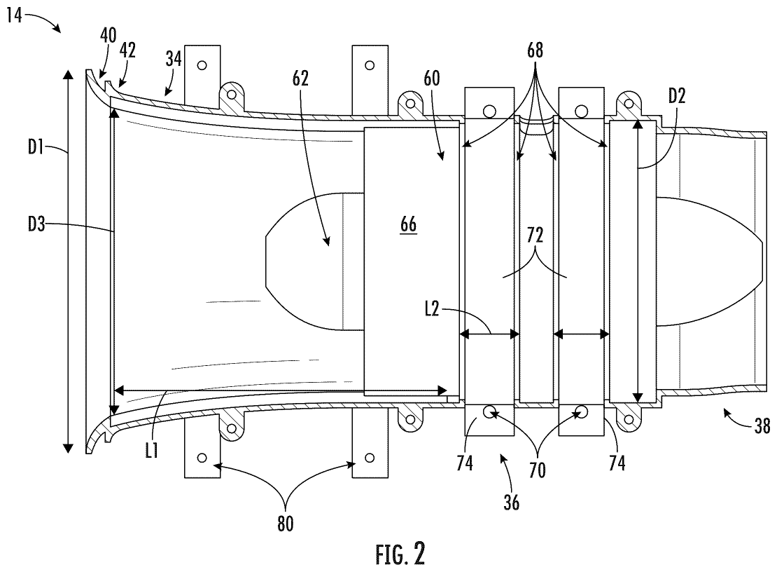

FIG. 2 illustrates a partial cutaway view of the air duct body 26 having a portion of the air duct body 26 removed. The air inlet 22 is formed at an upstream end of the air duct body 26. In some aspects, the upstream end of the air duct body may include a bell-shaped section 34. The bell-shaped section 34 may include a maximum bell diameter D1 and smoothly and continuously transitions to match the smaller diameter D2 of the cylindrical section 36 (described below). In some embodiments, the bell-shaped section 34 may assist in creating beneficial airflow properties through the air duct 20.

The bell-shaped section 34 may include a fluted portion 40 disposed at the air inlet 22 and formed from the air duct body 26. Downstream of the fluted portion 40, the air duct body 26 may include a flange or lip 42 at which the air duct body 26 forms a larger inner diameter than an inner diameter D3 of the fluted portion adjacent to the flange 42. The flange 42 may be formed such that a dampening material 76 (described in further detail below) may be provided about an inner circumference of the air duct body 26 in the bell-shaped section 34. In this manner, an inner surface of the fluted portion 40 and an inner surface of the dampening material 76 within the bell-shaped section 34 may have a generally smooth transition therebetween. In other words, as illustrated in FIG. 2, the inner diameter D3 of the fluted portion 40 adjacent to the flange 42 and the inner diameter of the dampening material 76 adjacent to the flange 42 are substantially the same. The present inventors have found that the substantially smooth and continuous transition from the bell-shaped section 34 to the cylindrical section 36, including the dampening material 76 within the air duct body 26, ay assist in creating beneficial airflow properties through the air duct 20.

Downstream from the bell-shaped section 34 of the air duct 20 and air duct body 26 is a generally cylindrical section 36. Downstream from the generally cylindrical section 36, the air duct body 26 may include a coupling section 38 configured for coupling with a blower tube 28, elbow tube 30, bellows 32, or other coupling section of the blower unit 14.

A fan assembly 50 is provided within the air duct body 26 and includes a fan 52 and a motor 54 configured to drive the fan 52. The fan assembly 50 may further include a motor housing 56 configured to receive and support the motor 54. The motor housing 56 and motor 54 may be aligned coaxially with the fan 52. The motor housing 56 may be disposed within a shroud 60 and may be coupled to the shroud 60 by, e.g., a plurality of stator blades 58. The shroud 60, also referred to as a fan assembly housing, may circumferentially surround the motor housing 56. In some aspects, the shroud 60 may have a generally cylindrical shape. The shroud 60 may at least partially surround the fan 52. For instance, at least a portion of a fan hub 62 and the fan blades 64 of the fan 52 may be disposed within the shroud 60.

In some aspects of the present invention, the motor housing 54, stator blades 58, and shroud 60 may be permanently coupled together. For instance, the motor housing 54, stator blades 58, and shroud 60 may be formed from a same material, e.g., a thermoplastic material. In particular, the motor housing 54, stator blades 58, and shroud 60 may be joined together by vibration welding along vibratory weld joints 65. Vibration welding (also known as linear or friction welding) refers to a process in which two workpieces are brought in contact under pressure, and a reciprocating motion (vibration) is applied along the common interface in order to generate heat. The resulting heat melts the workpieces, and they become welded when the vibration stops and the interface cools. The present inventors have found that joining the motor housing 54, stator blades 58, and shroud 60 by vibration welding imparts specific benefits in the design of the fan assembly 50 of the blower 10 at least because the stator blades 58 may be formed independently. In the present invention, the stator blades 58 may be formed independently, enabling variably reduced diameters within the stator geometry that cannot be achieved with injection molding of the stator blades together with the motor housing and shroud. In contrast, in some conventional blowers, the motor housing, stator blades, and shroud may be formed integrally via injection molding as a single piece, which results in limitations in the design and tolerances of the angles of the stator blades.

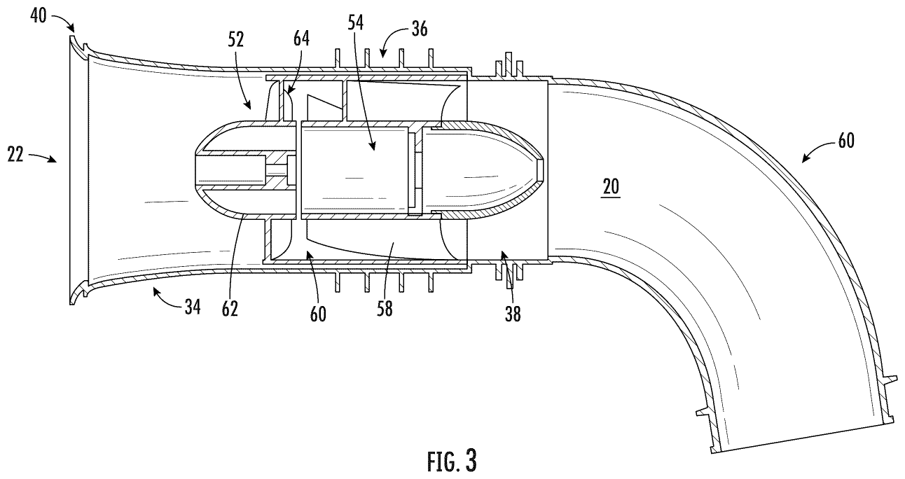

As illustrated in FIGS. 2-3, an outer surface 66 of the shroud 60 may be provided with one or more ribs 68 extending therefrom. The ribs 68 may be configured to form one or more channels 70 therebetween. As will be discussed in greater detail below, the channels 70 may be configured to receive a dampening material 76 therein such that the dampening material 76 extends around the outer surface 66 of the shroud 60.

In some aspects of the present invention, the shroud 60 is disposed within the air duct body 26 and spaced apart from the air duct body 26 so that the shroud 60 and the air duct body 26 are not in direct contact. For instance, a dampening material 76 may be provided between the shroud 60 and the air duct body 26. The air duct body 26 may have one or more receiving sections 74 configured to hold the shroud 60 in place relative to the air duct 20 and air duct body 26. The receiving sections 74 may be aligned with the channels 70 on the outer surface 66 of the shroud 60. In this manner, when the dampening material 76 is provided in the channels 70, the rings 72 of dampening material 76 may indirectly couple the shroud 60 to the air duct body 26. In some aspects of the invention, the rings 72 dampening material 76 may have a thickness in a range from about 1 mm to about 8 mm, such as from about 2 mm to about 5 mm, within the channels 70 surrounding the shroud 60. The rings 72 of dampening material 76 may have a length L2 along an axial direction of the air duct in a range from about 4 mm to about 50 mm. By virtue of this arrangement, mechanical vibration of the motor 54 and fan 52 during operation of the blower 10 may be vibrationally isolated and audible noise from such vibration may be reduced, thereby reducing noise generated by operation of the blower 10.

Turning back to the bell-shaped section 34, in some aspects of the invention, the dampening material 76 may be provided on the inner surface of the bell-shaped section 34 surrounding the air duct 20. For instance, the dampening material 76 may be provided along a length L1 of the air duct body 26 from the flange 42 to the cylindrical section 36. In some aspects of the invention, the dampening material 76 may have a thickness in a range from about 4 mm to about 30 mm within the bell-shaped section 34. In some aspects, the dampening material 76 within the bell-shaped section 34 may at least partially surround the shroud 60 of the fan assembly 50. For instance, the dampening material 76 within the bell-shaped section 34 may overlap with an upstream portion of the shroud 60. The length L1 may extend to an upstream channel 70 surrounding the shroud 60, or the length L1 may terminate upstream of the upstream channel 70. In some aspects, the dampening material 76 may be in the form of one or more pads of dampening material 76, such as two, three, four, or more pads of dampening material 76 disposed on an inner surface of the bell-shaped section 34. For instance, the dampening material 76 can surround at least a portion of the air duct 20 on multiple sides, or circumferentially around the bell-shaped section 34. By providing the dampening material 76 within the bell-shaped section 34 of the air duct body 22, the present inventors have found that superior reduction in noise may be achieved as compared to conventional blower tools.

The dampening material 76 may be a material known as a “Noise, Vibration, Harshness” (“NVH”) material. As defined previously in this disclosure, an NVH material may be material designed to be noise and/or vibration reducing, such as by absorbing noise and vibration, including but not limited to rubber, cork, foam, foam/film laminates, such as polyurethane foam, polyurethane elastomer, polyolefin elastomers and resins, acrylic liquid applied sound damping, polyester and/or polypropylene fibers. NVH materials may be in the form of foam, resins, liquid applied coating materials, flexible acoustic materials, flexible damping material, or any other suitable form. The NVH material(s) used in the blower 10 may include, but are not limited to, rubbers, foams, and/or plastics having noise, vibration, and harshness reduction properties. For instance, the NVH material may be applied directly to the air duct body 26 such as by spray or foam application, or the NVH material may be formed separately and then positioned with the air duct body 26 and/or shroud 60.

As described above, the air duct body 26 may be rigidly coupled to the main body 12 of the blower 10. For instance, a plurality of fastener receivers 80 may extend from an outer surface of the air duct body 26, e.g., along the bell-shaped section 34 and a plurality of fasteners (not shown) may fasten to the main body 12. As described previously, the air duct body 26 may be vibrationally isolated from the fan assembly 50 at least by the dampening material 76 in the channels 70 between the shroud 60 and air duct body 26. Moreover, the bell-shaped section 34 may be provided with dampening material 76 as described above. In this manner, the mechanical vibrations of the fan assembly 50 during operation of the blower may be isolated from the main body 12 even when the air duct body 26 is rigidly coupled to the main body 12 as described.

Further aspects of the disclosure are provided by one or more of the following embodiments:

A blower includes a main body; an air duct extending between an air inlet and an air outlet opposite the air inlet, the air duct including air duct body; a motor disposed in the air duct body between the air inlet and the air outlet; and a fan disposed in the air duct body between the air inlet and the air outlet. The fan is configured to rotate about a fan axis, and includes a fan hub and a plurality of fan blades extending radially outwardly from the fan hub to include a fan tip. The fan and the motor are disposed in a fan assembly housing. The blower further includes at least one Noise Vibration Harshness (NVH) material within the air duct, the NVH material being configured to isolate mechanical vibration of the housing from the air duct.

The blower of any one or more of the embodiments, wherein the air duct body is rigidly coupled with the main body.

The blower of any one or more of the embodiments, wherein the rigid coupling between the air duct body and the main body is upstream of the fan assembly housing.

The blower of any one or more of the embodiments, wherein the main body comprises a backpack support configured to be worn on a user's back.

The blower of any one or more of the embodiments, wherein a blower outlet tube is coupled to a downstream end of the air duct body, the air outlet being disposed at a downstream end of the blower outlet tube.

The blower of any one or more of the embodiments, wherein the downstream end of the air duct body is configured to nest inside an upstream end of the blower outlet tube.

The blower of any one or more of the embodiments, wherein the at least one NVH material is disposed within the air duct body.

The blower of any one or more of the embodiments, wherein at least a portion of the fan assembly housing is surrounded by the at least one NVH material.

The blower of any one or more of the embodiments, wherein the portion of the fan assembly housing is circumferentially surrounded by the at least one NVH material.

The blower of any one or more of the embodiments, wherein the at least one NVH material surrounds an inner surface of the air inlet.

The blower of any one or more of the embodiments, wherein the at least one NVH material extends along the air duct from the air inlet to the fan assembly housing.

The blower of any one or more of the embodiments, wherein the at least one NVH material comprises one or more vibration isolation rings surrounding a circumference of the fan assembly housing.

The blower of any one or more of the embodiments, wherein each of the one or more vibration isolation rings are spaced apart from both an upstream end and a downstream end of the fan assembly housing.

The blower of any one or more of the embodiments, wherein the fan assembly housing is isolated from the air duct body by the at least one NVH material.

The blower of any one or more of the embodiments, wherein the at least on NVH material comprises at least two sections of NVH material separated by a gap.

The blower of any one or more of the embodiments, wherein the fan assembly housing comprises a motor housing surrounded by a shroud, the fan assembly housing further comprising a plurality of stator blades extending between the motor housing and the shroud, wherein the stator blades are joined to the motor housing and to the shroud by vibratory welding.

A method of manufacturing a motor assembly for a blower, the method including steps of: forming a cylindrical motor housing, forming a plurality of stator blades, and forming a cylindrical shroud. The method further includes steps of joining the plurality of stator blades to an outer surface of the motor housing, and joining the plurality of stator blades to an inner surface of the shroud. At least one of the plurality of stator blades is joined to the motor housing and/or the shroud by vibrational welding.

The method of any one or more of the embodiments, wherein each of the plurality of stator blades are joined to the motor housing by vibrational welding.

The method of any one or more of the embodiments, wherein each of the plurality of stator blades are joined to the shroud by vibrational welding.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A blower comprising: a main body; an air duct extending between an air inlet and an air outlet opposite the air inlet, the air duct including air duct body; a motor disposed in the air duct body between the air inlet and the air outlet; a fan disposed in the air duct body between the air inlet and the air outlet, the fan configured to rotate about a fan axis, the fan including a fan hub and a plurality of fan blades extending radially outwardly from the fan hub to include a fan tip; the fan and the motor being disposed in a fan assembly housing; further comprising at least one Noise Vibration Harshness (NVH) material within the air duct, the NVH material being configured to isolate mechanical vibration of the housing from the air duct.

2. The blower of claim 1, wherein the air duct body is rigidly coupled with the main body.

3. The blower of claim 2, wherein the rigid coupling between the air duct body and the main body is upstream of the fan assembly housing.

4. The blower of claim 1, wherein the main body comprises a backpack support configured to be worn on a user's back.

5. The blower of claim 1, wherein a blower outlet tube is coupled to a downstream end of the air duct body, the air outlet being disposed at a downstream end of the blower outlet tube.

6. The blower of claim 5, wherein the downstream end of the air duct body is configured to nest inside an upstream end of the blower outlet tube.

7. The blower of claim 1, wherein the at least one NVH material is disposed within the air duct body.

8. The blower of claim 1, wherein at least a portion of the fan assembly housing is surrounded by the at least one NVH material.

9. The blower of claim 8, wherein the portion of the fan assembly housing is surrounded by the at least one NVH material on multiple sides.

10. The blower of claim 8, wherein the portion of the fan assembly housing is circumferentially surrounded by the at least one NVH material.

11. The blower of claim 1, wherein the at least one NVH material surrounds an inner surface of the air inlet.

12. The blower of claim 10, wherein the at least one NVH material extends along the air duct from the air inlet to the fan assembly housing.

13. The blower of claim 1, wherein the at least one NVH material comprises one or more vibration isolation rings surrounding a circumference of the fan assembly housing.

14. The blower of claim 12, wherein each of the one or more vibration isolation rings are spaced apart from both an upstream end and a downstream end of the fan assembly housing.

15. The blower of claim 1, wherein the fan assembly housing is isolated from the air duct body by the at least one NVH material.

16. The blower of claim 1, wherein the at least on NVH material comprises at least two sections of NVH material separated by a gap.

17. The blower of claim 1, wherein the fan assembly housing comprises a motor housing surrounded by a shroud, the fan assembly housing further comprising a plurality of stator blades extending between the motor housing and the shroud, wherein the stator blades are joined to the motor housing and to the shroud by vibratory welding.

18. A method of manufacturing a motor assembly for a blower, the method comprising steps of: forming a cylindrical motor housing; forming a plurality of stator blades; forming a cylindrical shroud; joining the plurality of stator blades to an outer surface of the motor housing; and joining the plurality of stator blades to an inner surface of the shroud; wherein at least one of the plurality of stator blades is joined to the motor housing and/or the shroud by vibrational welding.

19. The method of claim 17, wherein each of the plurality of stator blades are joined to the motor housing by vibrational welding.

20. The method of claim 17, wherein each of the plurality of stator blades are joined to the shroud by vibrational welding.
